(19) United States
(12) Patent Application Publication
(10) Pub. No.: US 2005/0261789 A1
(43) Pub. Date: Nov. 24, 2005

(54) Audio wireless transmission and receiving and amplifying system

(76) Inventor: Pao Shou Chen, Taipei (TW)

Correspondence Address: RABIN & BERDO, P.C.;Suite 500, 1101 14 Street, N.W., Washington, DC, 20005, US

(21) Appl. No.: 10/945,890

(22) Filed: Sep. 22, 2004

(30) Foreign Application Priority Data
May 18, 2004 (TW) 93113958

(51) Int. Cl. G06F 17/00; H04B 5/00

(52) U.S. Cl. 700/94; 381/79

(57) ABSTRACT

An audio wireless transmission and receiving and amplifying system which includes an audio wireless transmission device and an audio receiving and amplifying device is provided. The audio wireless transmission device aims to encode an analog audio signal to conform to Bluetooth wireless transmission standard for transmission. The audio receiving and amplifying device receives the audio signal conformed to the Bluetooth wireless transmission standard; the audio signal passes through an analog/digital power amplifier and is output. The provided system may be equipped with many different types of multimedia players to receive, record and broadcast multimedia audio signals in a wireless fashion.

This Non-provisional application claims priority under 35 U.S.C. § 119(a) on Patent Application No(s). 093113958 filed in Taiwan on May 18, 2004, the entire contents of which are hereby incorporated by reference.

### BACKGROUND OF THE INVENTION

1. Field of the Invention

The present invention relates to an audio wireless transmission and receiving and amplifying system and more particularly to an audio wireless transmission and receiving and amplifying system that adopts a Bluetooth wireless network transmission standard.

2. Related Art

Video and audio multimedia players such as DVD players are widely used in general households nowadays. The home theater system equipped with 5.1 sound track speakers is also popular. However, while installing the speakers of the home theater system at home, many consumers find out that wiring the surround speakers is difficult. They also spoil the existing house decoration and affect the aesthetic appealing. Hence many users rather not use surround speakers. This results in a waste of resources and downgrade of the acoustic effect. It fails to achieve the requirements and effects of the home theater.

To remedy this problem, wireless surround speakers have been developed and introduced. The present products on the market that adopt wireless techniques can be divided in many types: first, the unique transmission technique for 2.4 GHz spectrum. It is a non-standard transmission format not compatible to the wireless transmission modules of other vendors, and generally has five to eight channels allowable for consumers to select and set. The second type is one that adopts 2.4 GHz IEEE802.11 b/g WLAN technique. The second type adopts the IrDA infrared transmission technique.

While the aforesaid wireless transmission techniques can meet the requirements of wireless surround speakers, they also create new problems. Except the infrared transmission technique, all other wireless transmission techniques adopt a fixed spectrum. Interference frequently occurs, and the receiving quality is affected. As a result, noises or interruptions happen to the generated sound. Sounds are different from pictures. A picture may have instantaneous flicks that do not bother most people. However, when sound is defective, it is recognizable instantly. This is especially serious in the IEEE802.11b/g wireless network, which has multiple devices operating in the same 2.4 GHz spectrum. Interference among the devices occurs frequently. And the lower power devices suffer easily from signal interruption. To overcome this problem, the common approach is to increase the emission power to maintain sound quality. But such an approach causes interruption of the wireless network or decrease of the spectrum width.

On the other hand, the IrDA infrared transmission technique also has problems, such as angle and blocking of transmission and receiving also may cause interruption of sound unless the receiving and transmission modules are located on a higher elevation to prevent the infrared transmission from being interrupted by moving people.

Refer to FIG. 1 for a conventional technique that places wireless receiving and transmission modules in an amplifier and speakers. A multimedia player 10 decodes multimedia signals and outputs audio and video signals. The video signals are directly displayed on a display device 20, while the audio signals are transmitted to an amplifier 30 for processing and delivering. The amplifier 30 includes a decoder 31, a digital to analog converter 32, an encoder 33, an audio amplifier 34 and a transmitter 35. The decoder 31 decodes audio signals to other audio signals of different sound tracks. Take 5.1 sound tracks for instance, the decoded audio signals may be divided into a FL (front left) sound track, FR (front right) sound track, C (center) sound track, an SW (subwoofer) sound track, SL (surround left) sound track, and SR (surround right) sound track. The digital to analog converter 32 converts the decoded signals to analog signals that are amplified by the audio amplifier 34 and output to a first speaker 41, a second speaker 42, a third speaker 43, and a third speaker 44. The encoder 33 encodes the decoded audio signals to corresponding radio signals that conform to the transmission standard and are transmitted through the transmitter 35. A fifth speaker 45 and a sixth speaker 46 are provided, including respectively a built-in receiver 451 and 461. The received signals are decoded by decoders 452 and 462, and converted by digital to analog converters 453 and 463, and pass through channel selectors 454 and 464, are amplified by amplifiers 455 and 465, and output through the fifth and the sixth speakers 45 and 46. Hence consumers have to purchase the whole set of home theater amplifier and wireless speakers, or individual wireless surround speakers and transmission modules. They are expensive. And the original surround speakers are useless.

Thus there is still room for improvement in the wireless surround system of the present home theater, such as how to overcome the wireless transmission interference, how to make use of the existing speakers and whether the existing speakers may serve as independent wireless speakers, etc. Moreover, an audio wireless transmission and receiving and amplifying apparatus, adaptable to different multimedia players and capable of resisting the same spectrum interference, is a technique urgently needed at present.

### SUMMARY OF THE INVENTION

Therefore, the primary object of the invention is to provide an audio wireless transmission and receiving and amplifying system to solve the problems and disadvantages occurring to the conventional techniques.

To achieve the foregoing object, the invention provides an audio wireless transmission device, which is selectively coupled to a multimedia player. The multimedia player outputs at least one audio signal in an analog format. The transmission system includes an analog to digital converter to convert the analog audio signal to a digital audio signal, an encoder connecting to the analog to digital converter to encode the digital audio signal to conform to Bluetooth transmission standard, and a Bluetooth transmitter connecting to the encoder to transmit the encoded audio signal.

To accomplish the object set forth above, the invention further provides an audio wireless receiving and amplifying device which includes a Bluetooth receiver to receive a digital audio signal that confirms to the Bluetooth transmission standard, a decoder connecting to the Bluetooth receiver to decode the digital audio signal conformed to the Bluetooth transmission standard, a digital to analog converter or a digital audio pulse width regulator connecting to the decoder to transform the decoded audio signal to an analog or pulse wave format, and an analog or digital power amplifier connecting to the digital to analog converter or the digital audio pulse width regulator to amplify the analog or pulse wave audio signal.

In one aspect, the audio wireless transmission and receiving and amplifying system of the invention includes an audio wireless transmission device to encode the analog audio signal to conform to the Bluetooth wireless transmission standard and transmit the encoded signal, and an audio wireless receiving and amplifying device to receive and amplify the audio signal that conforms to the Bluetooth wireless transmission standard.

According to the object and principle of the invention, the transmission and receiving and amplifying system provided by the invention is independent and may be integrated with the existing system.

According to the object and principle of the invention, the system also is adaptable to any multimedia players.

According to the object and principle of the invention, the system further overcomes the problem of audio wireless transmission interference.

According to the object and principle of the invention, the system may also serve as an independent audio wireless output amplifying system.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below illustration only, and thus are not limitative of the present invention, and wherein:

FIG. 1 is a schematic view of a conventional wireless theater system.

FIG. 2 is a block diagram of the audio wireless transmission and receiving and amplifying system of the invention.

FIG. 3 is a schematic view of an embodiment of the audio wireless receiving and amplifying device of the invention.

FIG. 4 is a schematic view of another embodiment of the audio wireless receiving and amplifying device of the invention.

FIG. 5 is a schematic view of yet another embodiment of the audio wireless receiving and amplifying device of the invention.

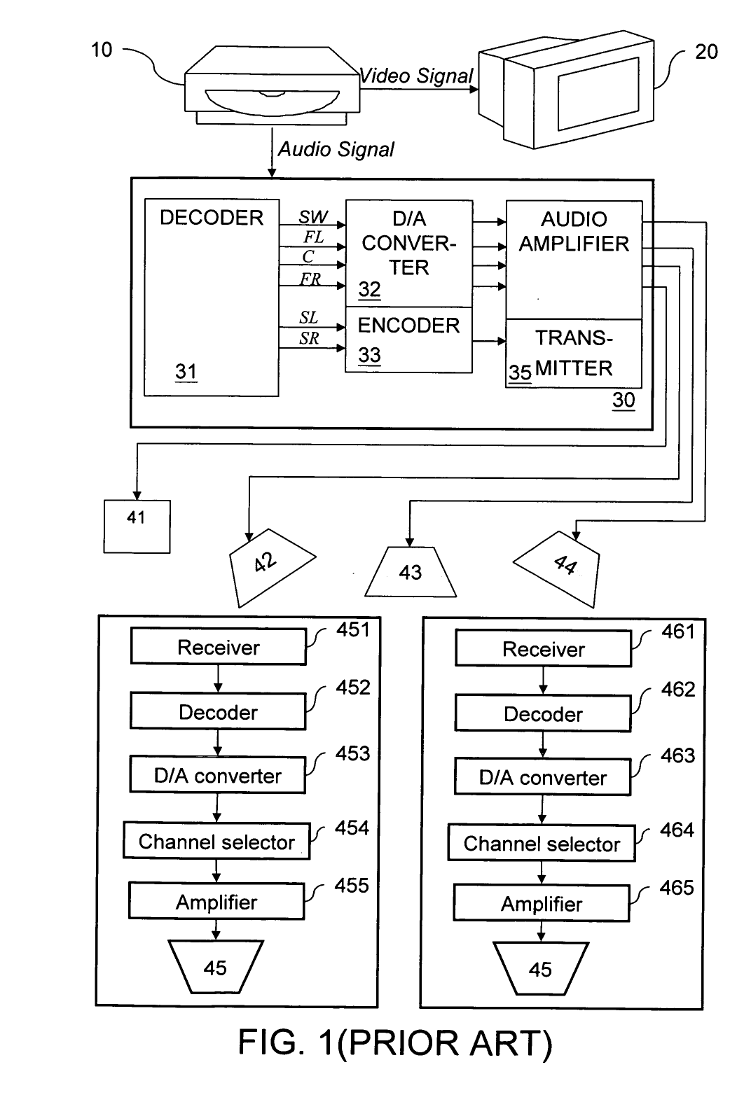

### DESCRIPTION OF THE PREFERRED EMBODIMENTS

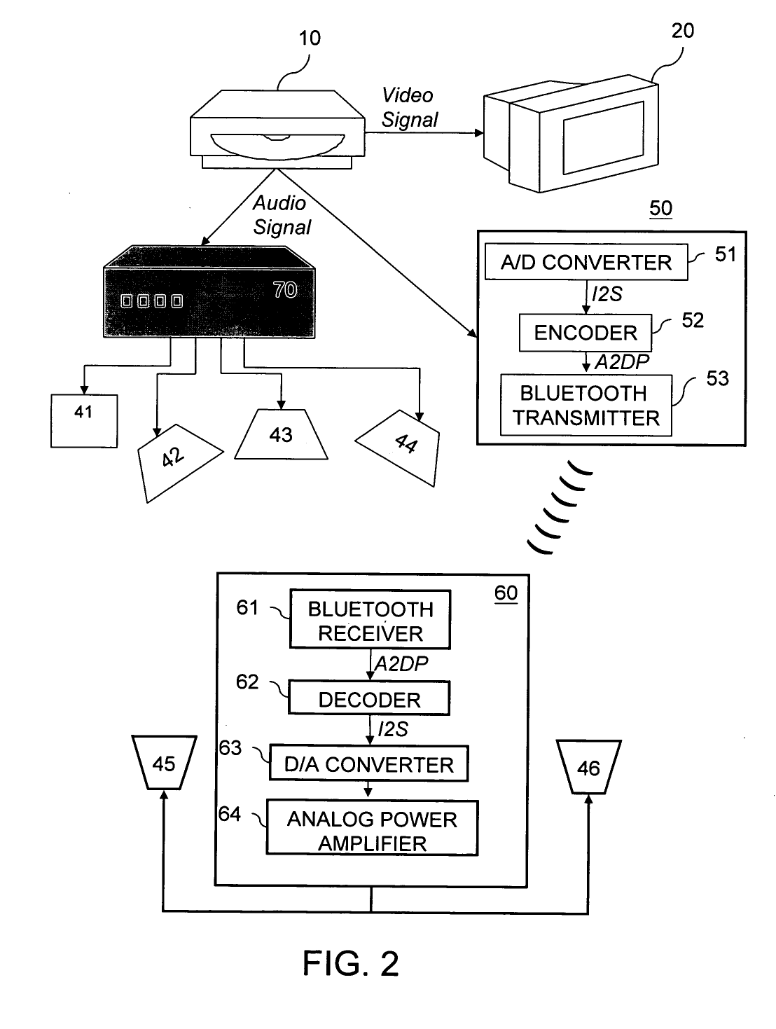

Refer to FIG. 2 for the audio wireless transmission and receiving and amplifying system of the invention that takes a home theater system as an example. It includes an audio wireless transmission device 50 and an audio wireless receiving and amplifying device 60 that are selectively connected to a multimedia player 10 (such as a DVD player). The multimedia player 10 outputs at least one audio signal and a video signal, which is displayed on a display device 20.

The audio signal of the multimedia player 10 is selectively linked to an amplifier 70 to amplify the audio signal output from the multimedia player 10. The amplified audio signal consists of an FL sound track, an FR sound track, a center sound track, and an SW sound track that are output respectively through a first speaker 41, a second speaker 42, a third speaker 43, and a fourth speaker 44.

In this embodiment, the audio wireless transmission device 50 and the audio wireless receiving and amplifying device 60 are directly used on the present home theater system. As shown in the drawing, the SL sound track and SR sound track output from the multimedia player 10 are delivered to the audio wireless transmission device 50, then the audio signal is transmitted to the audio wireless receiving and amplifying device 60 according to the Bluetooth transmission standard to be amplified and output through speakers 45 and 46 to achieve a high quality video and audio surround effect for the home theater system in a wireless fashion.

The audio wireless transmission device 50 encodes the analog audio signal to an audio signal conforming to the Bluetooth wireless transmission standard for transmission. The audio wireless receiving and amplifying device 60 receives and amplifies the audio signal conformed to the Bluetooth wireless transmission standard. The audio wireless transmission device 50 includes an analog to digital converter 51, an encoder 52 and a Bluetooth transmitter 53. The analog to digital converter 51 transforms the analog audio signal to a digital format. The encoded audio signal conforms to I2S (Inter-IC Sound) format. The encoder 52 is connected to the analog to digital converter 51 to encode the digital audio signal of I2S format to become a digital signal conforming to the Bluetooth transmission standard. The Bluetooth transmitter 53 is connected to the encoder 52 to transmit the encoded digital signal.

The audio wireless receiving and amplifying device 60 includes a Bluetooth receiver 61, a decoder 62, a digital to analog converter 63 and an analog power amplifier 64 which is preferably an analog Class D power amplifier. (The analog Class D power amplifier has a better performance than the conventional analog Class A/AB power amplifiers). The Bluetooth receiver 61 receives digital signals that conform to the Bluetooth transmission standard format. The decoder 62 is connected to the Bluetooth receiver 61 to decode the digital signals to become audio signals conforming to I2S format. The digital to analog converter 63 is connected to the decoder 62 to transform the decoded audio signals to an analog format. The analog power amplifier 64 is connected to the digital to analog converter 63 to amplify the analog audio signals.

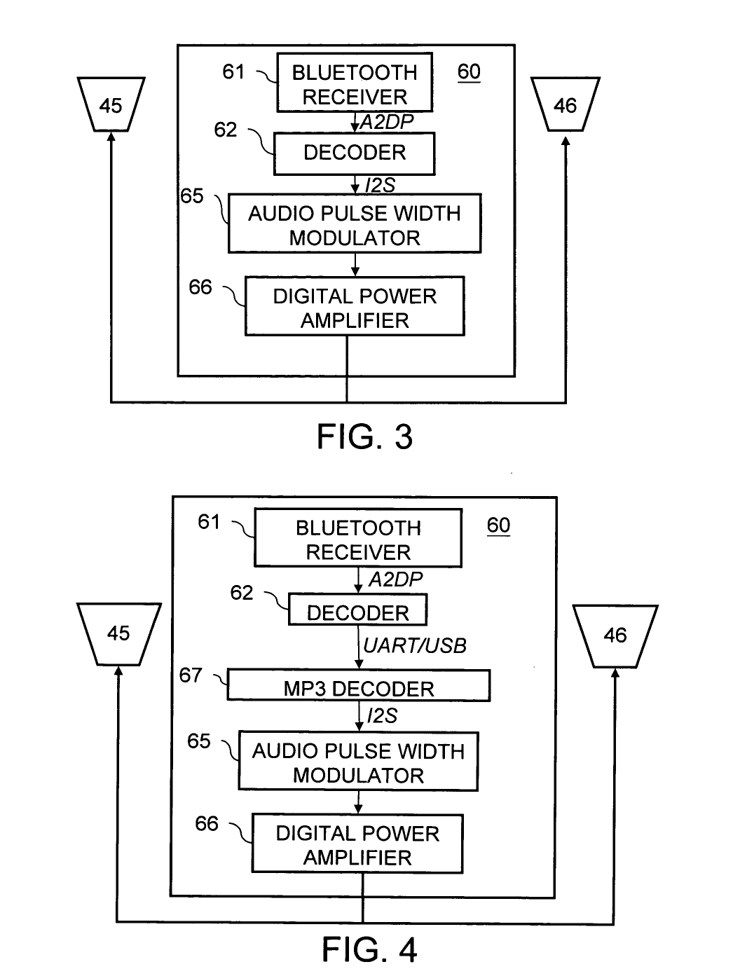

Refer to FIG. 3 for another embodiment of the audio wireless receiving and amplifying device 60. It includes a Bluetooth receiver 61, a decoder 62, a digital audio pulse width regulator 65 and a digital power amplifier 66 which is preferably a digital Class D power amplifier. (The digital Class D power amplifier has a better performance than the conventional analog Class A/AB power amplifiers). The Bluetooth receiver 61 receives digital signals that conform to the Bluetooth transmission standard format. The decoder 62 is connected to the Bluetooth receiver 61 to decode the digital signals to become audio signals conforming to I2S format. The digital audio pulse width regulator 65 is connected to the decoder 62 to transform the decoded audio signals to a pulse wave format. The digital power amplifier 66 is connected to the digital audio pulse width regulator 65 to amplify the pulse wave audio signals.

In addition, the audio wireless transmission device 50 and the audio wireless receiving and amplifying device 60 may be directly adopted on other multimedia players, such as game machines, high class stereo systems, multimedia computers, multimedia handsets, telephones, and the like. As shown in FIG. 2, the audio wireless transmission device 50 is independent from the amplifier 70, and receives the general analog music signals. Hence it not only can be used in the surround environment of the home theater, but also may be externally connected to the general music players, such as personal music players, computers, radios and the like. And the music may be broadcast through speakers via wireless Bluetooth and the audio wireless receiving and amplifying device 60.

The wireless speakers now being commonly used are set on a fixed spectrum. Once interference occurs to the spectrum, audio quality immediately suffers. Of course this is undesirable.

Based on the principle of the invention, the audio wireless transmission device 50 and the audio wireless receiving and amplifying device 60 adopt the technology that conforms to wireless Bluetooth IEEE standard 802.15.1. This technology is mainly used in handsets and computers for transmitting sound and data. The operation spectrum is between 2.400 GHz and 2.4835 GHz, and is divided into 79 channels. The receiving device and transmission device have to mate each other, and the transmission end and the receiving end have frequency hopping concurrently and constantly, to move away from the interference spectrum. Its anti-interference property is better than other wireless transmission methods.

In the audio wireless transmission device 50 and the audio wireless receiving and amplifying device 60, the Bluetooth transmission standard adopts the Advanced Audio Distribution Profile (A2DP) protocol. It is different from the HFP (Hands Free Profile) protocol now widely used on the handsets. Moreover, the invention employs the wireless Bluetooth SBC (Sub Band Codec) compression technique. The sampling frequency is 44.1 kHz. It provides high quality wireless transmission for music, and has an excellent wireless transmission quality.

According to the principle of the invention, the audio wireless transmission device 50 may be selectively connected to any multimedia players. The audio wireless receiving and amplifying device 60 may also be used independently to receive and amplify wireless signals that conform to the Bluetooth transmission standard.

The invention adopts the wireless Bluetooth A2DP protocol. The A2DP protocol not only supports the SBC format, but also supports transmission in MPEG1/2/3 audio formats, especially the MP3 music format which is widely used in network music. At present, many MP3 players, and some PDAs and handsets also support the MP3 format for music broadcasting. To include the Bluetooth modules in these players and support the A2DP protocol, MP3 music may be transmitted, through the wireless Bluetooth, to the audio wireless receiver of the invention for broadcasting. Referring to FIG. 4, the audio wireless receiving and amplifying device 60, in addition to the Bluetooth receiver 61 and decoder 62, also includes a MP3 decoder 67 connecting to the decoder 62 to decode the digital signals conformed to the Bluetooth transmission standard through a UART (Universal Asynchronous Receiver/Transmitter) or USB (Universal Serial Bus) interface to become audio signals (I2S) conforming to the MP3 digital music format. The digital audio pulse width regulator 65 is connected to the MP3 decoder 67 to transform the decoded audio signals (I2S) to a pulse wave format. The digital power amplifier 66 is connected to the digital audio pulse width regulator 65 to amplify the audio signal of the pulse wave format.

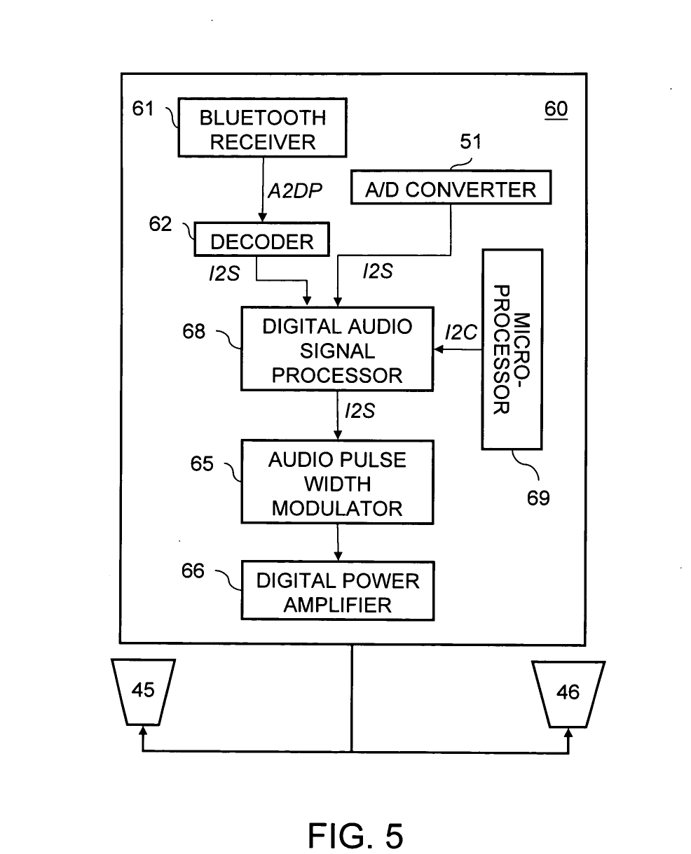

Referring to FIG. 5, the audio wireless receiving and amplifying device 60, in addition to the Bluetooth receiver 61 and decoder 62, further includes a digital audio signal processor 68, an analog to digital converter 51 and a microprocessor 69. The digital audio signal processor 68 is connected to the decoder 62 and the analog to digital converter 51 to perform a digitization process of sound volume for the standard digital audio signals (I2S). The microprocessor 69 is connected to the digital audio signal processor 68 to control audio input selection and digital audio signals through the I2C control signals. The digital audio signal processor 68 is connected to the digital audio pulse width regulator 65 to transform the processed audio signal to the pulse wave format. The digital power amplifier 66 is connected to the digital audio pulse width regulator 65 to amplify the pulse wave audio signal. Hence the audio wireless receiving and amplifying device 60 may also function as an independent two sound tracks amplifier.

In the foregoing embodiments, the Bluetooth receiver 61 and Bluetooth transmitter 53 used the GDM1002 chip of GCT Co., the decoder 62 and encoder 52 used the GDM1202 of GCT Co., the MP3 decoder 67 used the PNX0101 chip of Philips Co., the digital audio pulse width regulator 65 used the TAS5010 chip of TI Co., the digital power amplifier 66 used the TAS5112 chip of TI Co., the digital to analog converter 63 used PCM1802 chip of TI Co., the microprocessor controller 69 used the M68HC908 chip of Motorola Co., the analog power amplifier 64 used the TA2021B chip of Tripath Co., the digital audio signal processor 68 used the TAS 3001 chip of TI Co., and the analog to digital converter 51 used the PCM1754 chip of TI Co.

The surround speakers of the conventional home theater systems mostly are active speakers. The rear stage power-amplifying chip has to be planted into the speaker chest and connected to an external electric power to function. This is a constraint in utilization. And the system is more expensive. By contrast, the audio wireless transmission device and audio wireless receiving and amplifying device of the invention may be selectively separated or put together when in use, and is adaptable to the existing home theater systems without alteration or additional design.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. An audio wireless transmission apparatus for selectively connecting to a multimedia player which outputs at least one analog audio signal, comprising:
an analog to digital converter to convert the analog audio signal to a digital audio signal;
an encoder connected to the analog to digital converter to encode the digital audio signal to conform to a Bluetooth transmission standard; and
a Bluetooth transmitter connected to the encoder to transmit the encoded audio signal.

2. The audio wireless transmission apparatus of claim 1, wherein the digital audio signal conforms to I2S standard.

3. The audio wireless transmission apparatus of claim 1, wherein the Bluetooth transmission standard is Advanced Audio Distribution Profile (A2DP) protocol.

4. An audio wireless receiving and amplifying apparatus, comprising:
a Bluetooth receiver to receive a digital audio signal which conforms to a Bluetooth transmission standard;
a decoder connected to the Bluetooth receiver to decode the digital audio signal;
a digital to analog converter connected to the decoder to convert the decoded audio signal to an analog format; and
an analog power amplifier connected to the digital to analog converter to amplify the analog audio signal.

5. The audio wireless receiving and amplifying apparatus of claim 4, wherein the digital audio signal conforms to I2S standard.

6. The audio wireless receiving and amplifying apparatus of claim 4, wherein the Bluetooth transmission standard is Advanced Audio Distribution Profile (A2DP) protocol.

7. The audio wireless receiving and amplifying apparatus of claim 4, wherein the analog power amplifier is an analog Class D power amplifier.

8. An audio wireless receiving and amplifying apparatus, comprising:
a Bluetooth receiver to receive a digital audio signal which conforms to Bluetooth transmission standard;
a decoder connected to the Bluetooth receiver to decode the digital audio signal;
a digital audio pulse width regulator connected to the decoder to convert the decoded audio signal to conform a pulse wave format; and
a digital power amplifier connecting to the regulator to amplify the audio signal conforming the pulse wave format.

9. The audio wireless receiving and amplifying apparatus of claim 8, wherein the digital audio signal conforms to I2S standard.

10. The audio wireless receiving and amplifying apparatus of claim 8, wherein the Bluetooth transmission standard is Advanced Audio Distribution Profile (A2DP) protocol.

11. The audio wireless receiving and amplifying apparatus of claim 8, wherein the power amplifier is a digital Class D power amplifier.

12. The audio wireless receiving and amplifying apparatus of claim 8, further compsises an MP3 decoder connected to the decoder for decoding the digital audio signal from the Bluetooth transmission standard to an MP3 standard.

13. An audio wireless receiving and amplifying apparatus, comprising:
a Bluetooth receiver to receive a digital audio signal which conforms to Bluetooth transmission standard;
a decoder connected to the Bluetooth receiver to decode the digital audio signal;
an analog to digital converter to receive an analog audio signal and convert the analog audio signal to a digital signal;
a digital audio signal processor connected to the decoder and the converter respectively, for digitizing the volume magnitude of the digital audio signal;
a micro processor connected to the digital audio signal processor for control option of audio input and the digital audio signal through inter-IC (I2C) control signal;
a digital audio pulse width regulator connected to the digital audio signal processor to convert the decoded audio signal to conform a pulse wave format; and
a digital power amplifier connected to the regulator to amplify the audio signal conforming the pulse wave format.

14. The audio wireless receiving and amplifying apparatus of claim 13, wherein the digital audio signal conforms to I2S standard.

15. The audio wireless receiving and amplifying apparatus of claim 13, wherein the Bluetooth transmission standard is Advanced Audio Distribution Profile (A2DP) protocol.

16. The audio wireless receiving and amplifying apparatus of claim 13, wherein the power amplifier is a digital Class D power amplifier.

17. An audio wireless transmission and receiving and amplifying system for selectively connecting to a multimedia player which outputs at least one analog audio signal, comprising:
an audio wireless transmission device to encode the analog audio signal to conform to Bluetooth wireless transmission standard for transmitting; and
an audio wireless receiving and amplifying device for receiving the audio signal that conforms to the Bluetooth wireless transmission standard.

18. The audio wireless transmission and receiving and amplifying system of claim 17, wherein the Bluetooth transmission standard is Advanced Audio Distribution Profile (A2DP) protocol.

19. The audio wireless transmission and receiving and amplifying system of claim 17, wherein the digital audio signal conforms to I2S standard.

20. The audio wireless transmission and receiving and amplifying system of claim 17, wherein the audio wireless transmission device comprises:
an analog to digital converter to convert the analog audio signal to a digital audio signal;
an encoder connecting to the analog to digital converter to encode the digital audio signal to conform to Bluetooth transmission standard; and
a Bluetooth transmitter connecting to the encoder to transmit the encoded audio signal.

21. The audio transmission and receiving and amplifying system of claim 17, wherein the audio wireless receiving and amplifying device comprises:
a Bluetooth receiver to receive a digital audio signal which conforms to Bluetooth transmission standard;
a decoder connecting to the Bluetooth receiver to decode the digital audio signal;
a digital to analog converter connecting to the decoder to convert the decoded audio signal to an analog format; and
an analog power amplifier connecting to the digital to analog converter to amplify the analog audio signal.

22. The audio wireless transmission and receiving and amplifying system of claim 21, wherein the analog power amplifier is an analog Class D power amplifier.

23. The audio wireless transmission and receiving and amplifying system of claim 17, wherein the audio wireless receiving and amplifying device comprises:
a Bluetooth receiver to receive a digital audio signal which conforms to Bluetooth transmission standard;
a decoder connecting to the Bluetooth receiver to decode the digital audio signal;
a digital audio pulse width regulator connecting to the decoder to convert the decoded audio signal to a pulse wave format; and
a digital power amplifier connecting to the digital to analog converter to amplify the pulse width audio signal.

24. The audio wireless transmission and receiving and amplifying system of claim 23, wherein the digital power amplifier is a digital Class D power amplifier.

25. The audio wireless transmission and receiving and amplifying system of claim 17, wherein the audio wireless receiving and amplifying device comprises:
a Bluetooth receiver to receive a digital audio signal which conforms to Bluetooth transmission standard;
a decoder connecting to the Bluetooth receiver to decode the digital audio signal;
an MP3 decoder connected to the decoder for decoding the digital audio signal from the Bluetooth transmission standard to an MP3 standard;
a digital audio pulse width regulator connecting to the decoder to convert the decoded audio signal to a pulse wave format; and
a digital power amplifier connecting to the digital to analog converter to amplify the pulse width audio signal.

26. The audio wireless transmission and receiving and amplifying system of claim 25, wherein the digital power amplifier is a digital Class D power amplifier.

27. The audio wireless transmission and receiving and amplifying system of claim 17, wherein the audio wireless receiving and amplifying device comprises:
a Bluetooth receiver to receive a digital audio signal which conforms to Bluetooth transmission standard;
a decoder connected to the Bluetooth receiver to decode the digital audio signal;
an analog to digital converter to receive an analog audio signal and convert the analog audio signal to a digital signal;
a digital audio signal processor connected to the decoder and the converter respectively, for digitizing the volume magnitude of the digital audio signal;
a micro processor connected to the digital audio signal processor for control option of audio input and the digital audio signal through inter-IC (I2C) control signal;
a digital audio pulse width regulator connected to the digital audio signal processor to convert the decoded audio signal to conform a pulse wave format; and
a digital power amplifier connected to the regulator to amplify the audio signal conforming the pulse wave format.

28. The audio wireless receiving and amplifying apparatus of claim 28, wherein the digital power amplifier is a digital Class D power amplifier.
